(19) United States
(12) Patent Application Publication
(10) Pub. No.: US 2021/0131143 A1
(43) Pub. Date: May 6, 2021

(54) LOCKING DEVICE FOR LOCKER

(71) Applicant: PASSTECH CO., LTD., Seongnam-si (KR)

(72) Inventor: HYUNG MO PARK, Gwangju-si (KR)

(21) Appl. No.: 16/671,746

(22) Filed: Nov. 1, 2019

(51) Int. Cl. E05B 47/06; E05B 65/02; E05B 47/00; E05B 9/02; G07C 9/00

(52) U.S. Cl. CPC E05B 47/0607; E05B 65/025; E05B 47/0012; E05B 9/02; E05B 2047/0095; G07C 9/00111; E05B 2047/0058; E05B 2047/0069; G07C 9/00182

(57) ABSTRACT

A locking device for a locker is proposed. The locking device for a locker is configured to lock or unlock a locker by using a smartphone instead of a user card, and to perform both the function of a deadbolt and the function of a spring latch using a latch operation lever. The locking device includes a locking unit that has a casing, a deadbolt latch, a latch operation lever, a stopper plate, a driving controller controlling the latch operation lever, a motor driving unit connected to the latch operation lever, and a battery unit, wherein an end portion of the deadbolt latch is locked to the stopper plate such that the deadbolt latch is not moved backward, thereby keeping a locker locked.

### BACKGROUND OF THE INVENTION

### Field of the Invention

The present invention relates to a locking device for a locker and, more particularly, to a locking device for a locker that can lock or unlock a locker by using a smartphone instead of a user card, and that can perform both the function of a deadbolt and the function of a spring latch using a latch operation lever.

### Description of the Related Art

In general, it is possible to control entry of unauthorized people and prevent unauthorized people from using a locker room by installing locker locks on lockers installed at an entrance or lockers installed in the locker room.

Such a locker lock has a spring latch-driving type and a deadbolt-driving type. According to the deadbolt-locking type, even if someone attempts to forcibly open a locker, the locker is not forcibly unlocked because a stopper of a deadbolt-locking mechanism holds the locker. Further, according to the spring latch-driving type, even if a latch is open or closed with a locker open, the locker can be closed, and if a closed locker is forcibly opened, the latch of a locking mechanism moves inside and the locker can be unlocked, so a separate locking device is attached to the front of the locker to solve this problem.

Accordingly, a mortise lock that is recently widely applied to the main room of an apartment, etc. has a deadbolt that has high safety and is installed separately from a doorknob. According to the mortise lock, a locking device is not installed integrally with a doorknob to which a latch bolt is coupled and a locking device to which a deadbolt is fastened is separately installed under a doorknob, thereby increasing durability of the doorknob. However, the mortise lock requires a large area for installation, so the mortise lock is difficult to install on a locker. Further, there is a problem that it is required to separately operate a doorknob and a locking device.

Further, most locking devices are composed of a lock and a corresponding key, but locking devices that can open/close lockers installed at a door and an entrance, or in an open space through a wireless near field communication technology using a cardkey (an access card, a keycard, or a user card) having a specific ID code therein are being popularized with development of the technology.

Such locking devices may include a keycard that functions as a key and a lock that is attached to a door/locker and the door/locker can be opened/closed by wireless recognition between the ID card and the lock. For example, according to a general system, a user checks out a reservation at the front desk in a resort hotel or a common hotel, receives a keycard (an RF card or a smart card), unlocks a lock of the designated room by contacting the keycard to the lock, and then enters the room.

According to this system using a keycard, a user has to always carry a keycard having a security code, etc. therein in order to open a designated door/lock, but users neglect keeping a keycard and lose the keycard due to inconvenience thereof in many cases.

On the other hand, recently, as communication technology and electronic devices are rapidly developed and it is easy to acquire information, users increasingly always carry communication devices (a smartphone, a tablet PC, etc.) that can be convenient to carry, and particularly, it is common to carry smartphones. Further, most users have a tendency to recognize carrying a communication device as a portion of life rather than responsibility, and this tendency can be easily found out from various study results or surveys of the tendency.

Accordingly, the present invention provides a locking device for a locker that can reduce the inconvenience that users have to carry a separate keycard while keeping security by using a smartphone that the users usually carry.

Accordingly, there is an increasing demand for a locking device for a locker that can be applied to lockers in a locker room or a normal room that people enter and leave by overcoming the disadvantages of existing locking devices and performing both the function of a deadbolt and the function of a spring latch, and that can reduce inconvenience of having to carry a separate keycard while keeping security using smartphones that users usually carry

### DOCUMENTS OF RELATED ART

(Patent Document 1) Korean Patent No. 10-1059753

### SUMMARY OF THE INVENTION

The present invention has been made in an effort to solve the problems described above and an objective of the present invention is to provide a locking device for a locker that can perform both the function of a deadbolt and the function of a spring latch.

Another objective of the present invention is to provide a locking system for a locker that improve convenience for users by reducing inconvenience of having to carry a separate keycard while keeping security using smartphones that users usually carry.

A locking device for a locker according to an aspect of the present invention includes a locking unit that includes: a casing including a cover that is attached to a side of a locker; a deadbolt latch being moved longitudinally forward by a pressing force from an elastic spring disposed in the casing such that a first end portion is exposed out of the casing, and having a locking portion on a second side; a latch operation lever disposed in the casing to be rotated by a motor force and rotating in a specific direction to be locked to or unlocked from the locking portion of the deadbolt latch, thereby restricting movement of the deadbolt latch; a stopper plate having a first side fixed to an inner side of the casing and a second side protruding in a movement area of the deadbolt latch; a driving controller controlling the latch operation lever to be rotated in the specific direction at a specific angle by the motor force; a motor driving unit connected to a side of the latch operation lever to rotate the latch operation lever; and a battery unit disposed at a side in the casing and being controlled to apply power to the motor driving unit by the driving controller, in which a second end portion of the deadbolt latch is locked to a second side of the stopper plate such that the deadbolt latch is not moved backward, thereby keeping a locker locked.

A pressing protrusion continuously protruding with a predetermined length may be formed on an outer circumference of the latch operation lever, so when the latch operation lever rotates a predetermined angle, the pressing protrusion may slide on an outer surface of the stopper plate, the stopper plate may be moved to the inner side of the casing, the second end portion of the deadbolt latch may be unlocked from the second end portion of the stopper plate, and the locker may be unlocked.

The casing may include: a housing having an open top and having a component installation space therein; and a cover plate having an electrical cable hole to expose an electrical cable disposed in the housing to the outside and being installed on a side of locker in close contact with the side of the locker while covering the open top of the housing, in which an accommodation guide groove extending with a predetermined length from the electrical cable hole and recessed with a predetermined length may be formed on an outer surface of the cover plate; and a connector accommodation groove having a size corresponding to a connector at an end of the electrical cable and accommodating the connector formed at an end of the guide groove.

The driving controller may include a locking unit module that determines a locked state of a locker by sensing a movement state of the deadbolt latch, and the locking unit module may include a plurality of first and second proximity sensors disposed at positions corresponding to movement positions of the deadbolt latch that correspond to the locked state and an unlocked state of the locker to determine the locked state and the unlocked state of the locker using sensing values acquired by the first and second proximity sensors.

The locking unit may keep security of a locker or disables the locker by examining validity of security data transmitted from a user card, and the locking device may further include a smartphone receiving and keeping validated security data from the locking unit, in which the smartphone may transmit the kept security data to the locking unit to induce disabling security of the locker.

The driving controller may include: a user card communication module receiving security data from the user card keeping the security data; a card control module authenticating the user card by examining validity of the security data received by the user card communication module; a locking database keeping security data validated by the card control module; a locking unit module disabling security of a locker when security data is validated and the user card is authenticated by the card control module; a smartphone communication module performing communication with the smartphone; and a phone control module controlling the smartphone communication module to transmit security data validated by the card control module to the smartphone when the smartphone requests security data validated by the card control module to be transmitted through the smartphone communication module.

The security data may include a multi-user setting, an encoding setting, a locking time setting, IDs, an available period of the security data, and a last use time setting, and the security data may be transmitted to the smartphone such that security of a locker is disabled by the smartphone.

A locking device for a locker according to another aspect of the present invention includes a locking unit that includes: a casing including a cover that is attached to a side of a locker; a spring latch being moved longitudinally forward by a pressing force from an elastic spring disposed in the casing such that a first end portion is exposed out of the casing, and having a locking portion on a second side; a latch operation lever disposed in the casing to be rotated by a motor force and rotating in a specific direction to be locked to or unlocked from the locking portion of the spring latch, thereby restricting movement of the deadbolt latch; a driving controller controlling the latch operation lever to be rotated in the specific direction at a specific angle by the motor force; a motor driving unit connected to a side of the latch operation lever to rotate the latch operation lever; and a battery unit disposed at a side in the casing and being controlled to apply power to the motor driving unit by the driving controller, in which when the spring latch moves forward/backward, the locking unit implements a spring latch function.

The casing may include: a housing having an open top and having a component installation space therein; and a cover plate having an electrical cable hole to expose an electrical cable disposed in the housing to the outside and being installed on a side of locker in close contact with the side of the locker while covering the open top of the housing, in which an accommodation guide groove extending with a predetermined length from the electrical cable hole and recessed with a predetermined length may be formed on an outer surface of the cover plate; and a connector accommodation groove having a size corresponding to a connector at an end of the electrical cable and accommodating the connector formed at an end of the guide groove.

The driving controller may include a locking unit module that determines a locked state of a locker by sensing a movement state of the deadbolt latch, and the locking unit module may include a plurality of first and second proximity sensors disposed at positions corresponding to movement positions of the deadbolt latch that correspond to the locked state and an unlocked state of the locker to determine the locked state and the unlocked state of the locker using sensing values acquired by the first and second proximity sensors.

The locking unit may keep security of a locker or disables the locker by examining validity of security data transmitted from a user card, and the locking device may further include a smartphone receiving and keeping validated security data from the locking unit, in which the smartphone may transmit the kept security data to the locking unit to induce disabling security of the locker.

The driving controller may include: a user card communication module receiving security data from the user card keeping the security data; a card control module authenticating the user card by examining validity of the security data received by the user card communication module; a locking database keeping security data validated by the card control module; a locking unit module disabling security of a locker when security data is validated and the user card is authenticated by the card control module; a smartphone communication module performing communication with the smartphone; and a phone control module controlling the smartphone communication module to transmit security data validated by the card control module to the smartphone when the smartphone requests security data validated by the card control module to be transmitted through the smartphone communication module.

The security data may include a multi-user setting, am encoding setting, a locking time setting, IDs, n available period of the security data, and a last use time setting, and the security data may be transmitted to the smartphone such that security of a locker is disabled by the smartphone.

A locking device for a locker according to another aspect of the present invention includes: a casing including a cover that is attached to a side of a locker; a deadbolt latch being moved longitudinally forward by a pressing force from an elastic spring disposed in the casing such that a first end portion is exposed out of the casing, and having a locking portion on a second side; a latch operation lever disposed in the casing to be rotated by a motor force and rotating in a specific direction such that a locking protrusion formed on a surface is locked to or unlocked from the locking portion of the deadbolt latch, thereby restricting movement of the deadbolt latch; a stopper plate having a first side fixed to an inner side of the casing and a second side protruding in a movement area of the deadbolt latch; a driving controller controlling the latch operation lever to be rotated in the specific direction at a specific angle by the motor force; a motor driving unit connected to a side of the latch operation lever to rotate the latch operation lever; and a battery unit disposed at a side in the casing and being controlled to apply power to the motor driving unit by the driving controller, in which a second end portion of the deadbolt latch is locked to a second side of the stopper plate by rotation of the latch operation lever to implement a deadbolt latch function such that the deadbolt latch is not moved backward; and a pressing protrusion continuously protruding with a predetermined length may be formed on an outer circumference of the latch operation lever, so when the latch operation lever rotates a predetermined angle, the pressing protrusion may slide on an outer surface of the stopper plate, the stopper plate may be moved to the inner side of the casing, and the second end portion of the deadbolt latch may move forward and backward without being locked to the second end portion of the stopper plate to implement a spring latch function.

According to the present invention, the latch operation lever is rotated such that the deadbolt latch changes a locker from a locked state to an open state. Further, the locking unit can implement both a deadbolt operation mode and a spring latch operation mode by operation of the stopper plate, so there is an effect that the locking device can be used for various purposes.

Further, a user can lock or unlock a locker in a locker room or a normal room while keeping security using a smartphone that he/she carries instead of carrying a user card, so there is an effect that convenience can be improved.

Further, since a guide groove and a connector accommodation groove are separately formed on the outer side of the cover plates such that the electrical cable makes a plane with the cover plate, it is very convenient to handle the cable and the remaining portion of the cable is stowed in the casing. Further, the connector at the end of the electrical cable is fixed in the connection accommodation groove and is directly coupled to a terminal of a control board body through a hole formed through a metal locker, so the connector can be very conveniently coupled. Therefore, there is an effect that the locking unit can be easily installed on a thin metal locker.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view showing a locking unit of a locking device for a locker according to an embodiment of the present invention;

FIG. 2 is a perspective view showing the locking unit according to an embodiment of the present invention with a cover thereof removed;

FIG. 3 is plan view showing the locking unit according to an embodiment of the present invention with the cover thereof removed;

FIG. 4 is a perspective view showing a cross-sectional structure the locking unit according to an embodiment of the present invention with the cover thereof removed;

FIGS. 5 and 6 are side views showing the cross-sectional structure shown in FIG. 4;

FIGS. 7A to 7C are views illustrating a locked state of a locker by rotation of a latch operation lever according to an embodiment of the present invention;

FIG. 8 is a view showing a detailed structure of a cover plate according to an embodiment of the present invention and a method of installing the locking unit on a common wooden locker;

FIG. 9 is a view showing an example when an electrical cable is accommodated on a cover plate according to an embodiment of the present invention;

FIG. 10 is a view showing in detail the locking unit installed on a thin metal locker in accordance with the stowing type shown in FIG. 9;

FIG. 11 is a view simply showing a control method that is performed with a smartphone using a locking unit;

FIG. 12 is a view showing the detailed configuration of a driving controller according to an embodiment of the present invention;

FIG. 13 is a perspective view showing a locking unit according to another embodiment of the present invention with a cover thereof removed;

FIG. 14 is a plan view showing the locking unit according to another embodiment of the present invention with the cover thereof removed;

FIG. 15 is a perspective view showing a cross-sectional structure the locking unit according to another embodiment of the present invention with the cover thereof removed;

FIGS. 16A to 16C are views illustrating an open state of a locker by rotation of a latch operation lever according to another embodiment of the present invention; and

FIGS. 17A to 17C are views illustrating a structure enabling a locking unit to perform both the function of a deadbolt latch and the function of a spring latch by rotation of a latch operation lever according to another embodiment of the present invention.

### DETAILED DESCRIPTION OF THE INVENTION

The present invention may be accomplished in various ways without departing from the spirit and the main features of the present invention. Accordingly, embodiments of the present invention are only examples and should not be construed as being limitative in all terms.

Terms used in the specification, “first”, “second”, etc., may be used to describe various components, but the components are not to be construed as being limited to the terms.

The terms are used only to distinguish one component from another component. For example, the “first” component may be named the “second” component, and vice versa, without departing from the scope of the present invention.

It is to be understood that when one element is referred to as being “connected to” or “coupled to” another element, it may be connected directly to or coupled directly to another element or be connected to or coupled to another element, having the other element intervening therebetween.

On the other hand, it is to be understood that when one element is referred to as being “connected directly to” or “coupled directly to” another element, it may be connected to or coupled to another element without the other element intervening therebetween.

Terms used in the present specification are used only in order to describe specific exemplary embodiments rather than limiting the present invention. Singular forms are intended to include plural forms unless the context clearly indicates otherwise.

It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Unless defined otherwise, it is to be understood that all the terms used in the specification including technical and scientific terms has the same meaning as those that are understood by those who skilled in the art.

It will be further understood that terms defined in dictionaries that are commonly used should be interpreted as having meanings that are consistent with their meanings in the context of the relevant art and will not be interpreted in an idealized or overly formal sense unless expressly so defined herein.

Exemplary embodiments of the present invention will be described in detail hereafter with reference to the accompanying drawings in order for those skilled in the art to be able to easily accomplish the present invention.

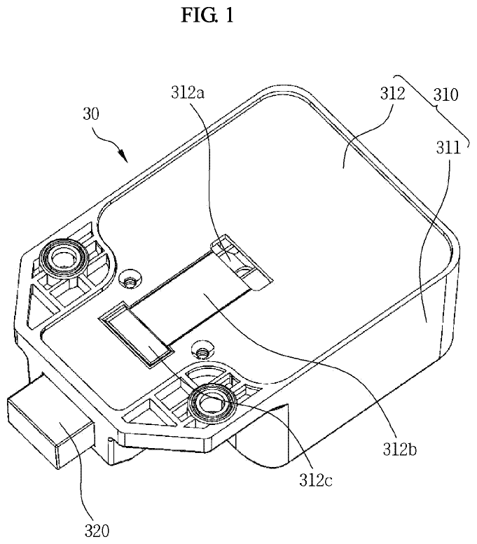

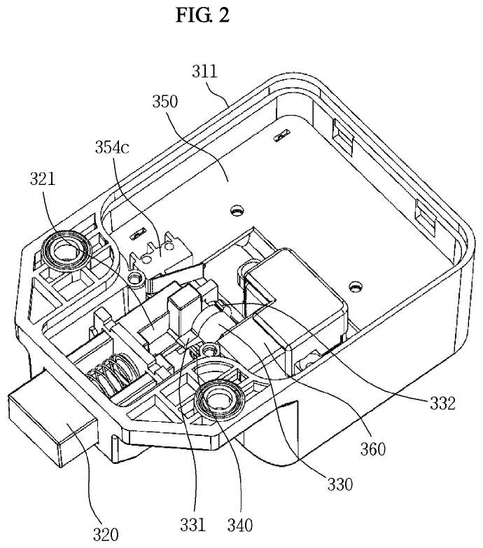

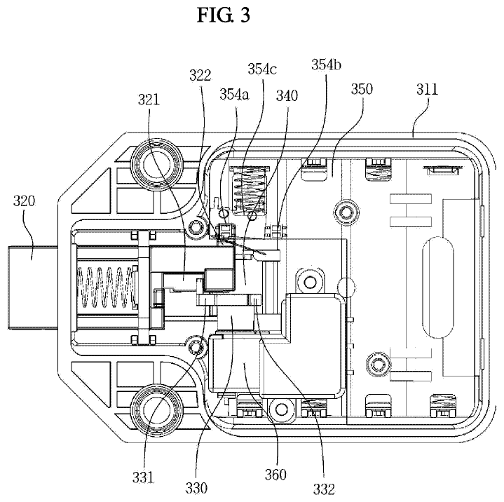

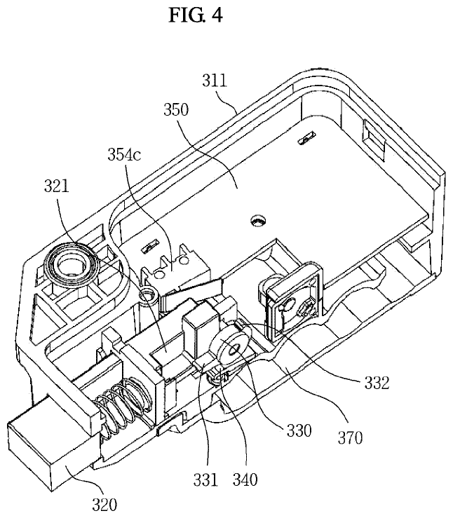

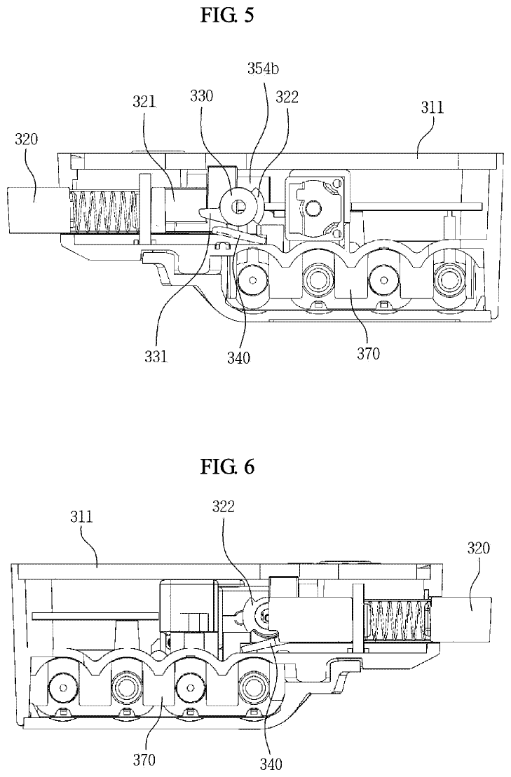

FIG. 1 is a perspective view showing a locking unit of a locking device for a locker according to an embodiment of the present invention, FIG. 2 is a perspective view showing the locking unit according to an embodiment of the present invention with a cover thereof removed, FIG. 3 is plan view showing the locking unit according to an embodiment of the present invention with the cover thereof removed, FIG. 4 is a perspective view showing a cross-sectional structure the locking unit according to an embodiment of the present invention with the cover thereof removed, and FIGS. 5 and 6 are side views showing the cross-sectional structure shown in FIG. 4.

Referring to the drawing, a locking unit 30 according to an embodiment of the present invention includes a casing 300, a deadbolt latch 320, a latch operation lever 330, a stopper plate 340, a driving controller 350, a motor driving unit 360, and a battery unit 370.

The casing 300 includes: a housing 311 having an open top and having an component installation space therein; and a cover plate 312 having an electrical cable hole 312a to expose an electrical cable installed in the housing 311 to the outside, covering the open top of the housing 311, and being installed in close contact with a side of a locker.

The deadbolt latch 320 that is disposed in the casing 300 with a first end exposed out of the casing 300 and moves forward/backward in the casing 300 to lock and unlock a locker. The deadbolt latch 320 is longitudinally moved forward by a pressing force from an elastic spring disposed in the casing 300 such that a first end portion is exposed out of the casing 300. A locking portion 321 separately protruding to come in contact with the latch operation lever 330 is formed on a second side of the deadbolt latch 320.

The latch operation lever 330 is disposed in the casing 300 to be rotated by a motor force. When the latch operation lever 330 is rotated in a specific direction, a locking protrusion 331 on a surface of the latch operation lever 330 is locked to or unlocked from the locking portion 321 on the other side of the deadbolt latch 320, thereby restricting forward/backward movement of the deadbolt latch 320.

The stopper plate 340 is disposed with a first side fixed to the bottom in the casing 300 and a second side protrudes to the area in which the deadbolt latch 320 moves. The second end portion of the deadbolt latch 320 is locked to a second surface of the stopper plate 340 such that the deadbolt latch 320 no longer moves inward in the casing 300, that is, backward, thereby keeping a locker locked.

A pressing protrusion 332 continuously protrudes with a predetermined length on the outer circumference of the latch operation lever 330. Accordingly, when the latch operation lever 330 is rotated to a predetermined angle, the pressing protrusion 332 also rotates and presses the outer surface, that is, the top of the stopper plate 340 while sliding on the top, whereby the second end portion protruding upward of the stopper plate 340 is moved to the inner surface of the casing 300.

As described above, the second surface of the stopper plate 340 moved to the inner surface of the casing 300 by the pressing protrusion 332 of the latch operation lever 330 is no longer positioned in the movement area of the deadbolt 320, so the second end portion of the deadbolt latch 320 is unlocked from the second end portion of the stopper plate 340 such that the deadbolt latch 320 can move inward in the casing 300, that is, backward, thereby unlocking a locker.

The driving controller 350 controls the latch operation lever 330 to be rotated in a specific direction or to a specific angle by a motor force. The driving controller 350 includes a locking unit module and determines a locked state of a locker by sensing a movement state of the deadbolt latch 320.

The locking unit module includes a plurality of first and second proximity sensors 354a and 354b disposed at positions corresponding to movement positions of the deadbolt latch 320 that correspond to a locked state and an unlocked state of a locker to determine the locked state and the unlocked state of the locker using sensing values acquired by the first and second proximity sensors 354a and 354b.

In more detail, the proximity sensors of the present invention may be photo sensors, a photo sensor receiver 322 is installed at the second end portion of the deadbolt latch 320, and the first proximity sensor 354a is installed at a position corresponding to the photo sensor receiver 322 at the movement position of the deadbolt latch 320 that corresponds to a locked state of a locker. Accordingly, when sensing is performed though the first proximity sensor 354a, it is determined that a locker is in a locked state.

Further, the second proximity sensor 354b is installed at a position corresponding to the photo sensor receiver 322 at the movement position of the deadbolt latch 320 that corresponds to an unlocked state of a locker, so when sensing is performed by the second proximity sensor 354b, it is determined that a locker is in an unlocked state with the first end of the deadbolt latch 320 moved backward without being exposed out of the casing 300. The sensing values obtained by the proximity sensors can be transmitted to the driving controller 350 so that the operation of a motor is controlled on the basis of the sensing values.

A micro switch 354c is installed at the second end portion of the deadbolt latch 320 so that the deadbolt latch 320 comes in contact with the micro switch 354c while reciprocating in the casing 300 and a locked state and an unlocked state of a locker are determined by connection/disconnection of the micro switch 354c.

The driving controller 350 controls operation of the latch operation lever 330 to lock or unlock a locker on the basis of a request from a user and the security control method for a locker is described in detail with reference to a control method of the driving controller 350 operating with a smartphone 40 to be described below.

The motor driving unit 360 is connected to a side of the latch operation lever 330 and is controlled by the driving controller 350 to rotate the latch operation lever 330 in a specific direction.

The battery unit 370 is disposed at a side in the casing 300 and is controlled by the driving controller 350 to apply power to the motor driving unit 360.

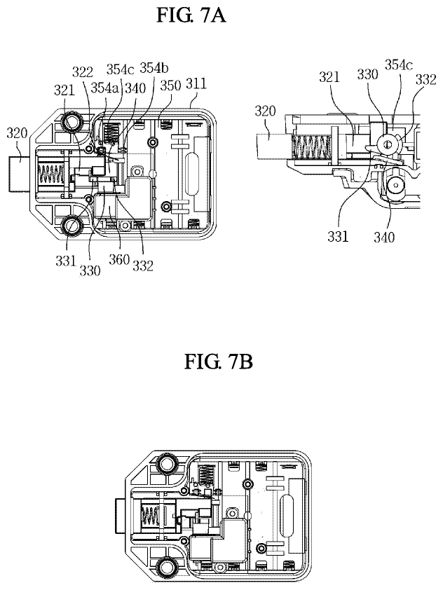

FIGS. 7A to 7C are views illustrating a locked state of a locker by rotation of a latch operation lever according to an embodiment of the present invention.

FIG. 7A shows that the first end portion of the latch operation lever 330 is fully exposed out of the casing 300 and a locker is in a locked state. In this unlocked state of a locker, as shown in a cross-sectional structure, the first end portion of the stopper plate 340 is positioned at the second end portion of the deadbolt latch 320, so the deadbolt latch 320 is no longer moved backward.

FIG. 7B shows the latch operation lever 330 rotating in response to an unlocking control instruction, in which as the latch operation lever 330 rotates, the locking protrusion 331 of the latch operation lever 330 is locked into a locking groove of the deadbolt latch 320, thereby moving the deadbolt latch 320 backward. Further, in the operation shown in FIG. 7B, the pressing protrusion 332 presses the top of the stopper plate 340 while rotating clockwise on the outer circumference of the latch operation lever 330, whereby the end of the stopper plate 340 comes out of the movement range of the deadbolt latch 320. In the state shown in FIG. 7B, the deadbolt latch 320 can freely move forward/backward, so it is possible to use the deadbolt latch 320 to open/close a locker using a spring latch 380 in addition to the function of locking a locker.

In FIG. 7C, the latch operation lever 330 pulls the deadbolt latch 320 while keeping rotating clockwise, so the first end portion of the deadbolt latch 320 moves into the casing 300, whereby a locker is unlocked.

As described above, according to an embodiment of the present invention, it is possible to change the deadbolt latch 320 from a state locking a locker to a state unlocking a locker by rotating the latch operation lever 330. Further, the locking unit 30 can implement both a deadbolt latch operation mode and a spring latch operation mode by the operation of the stopper plate 340.

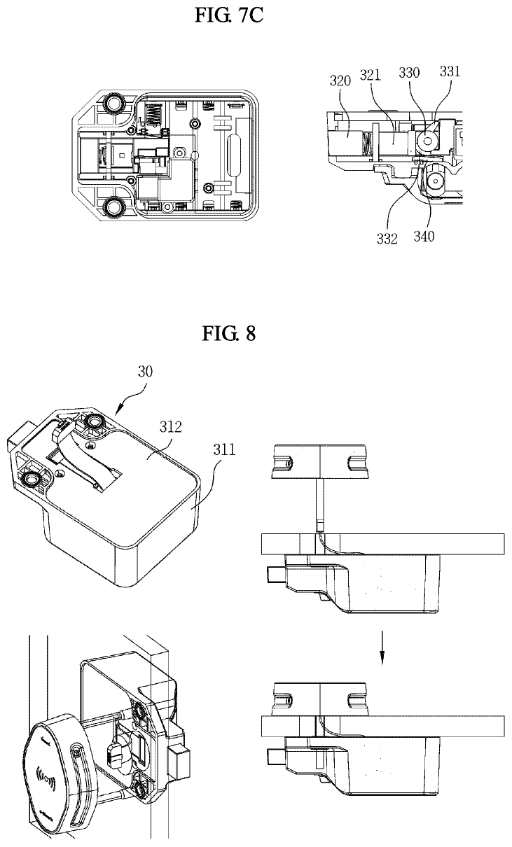

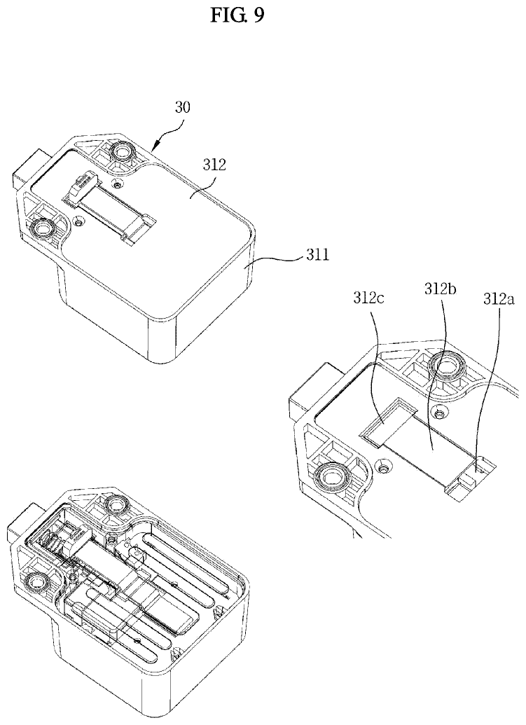

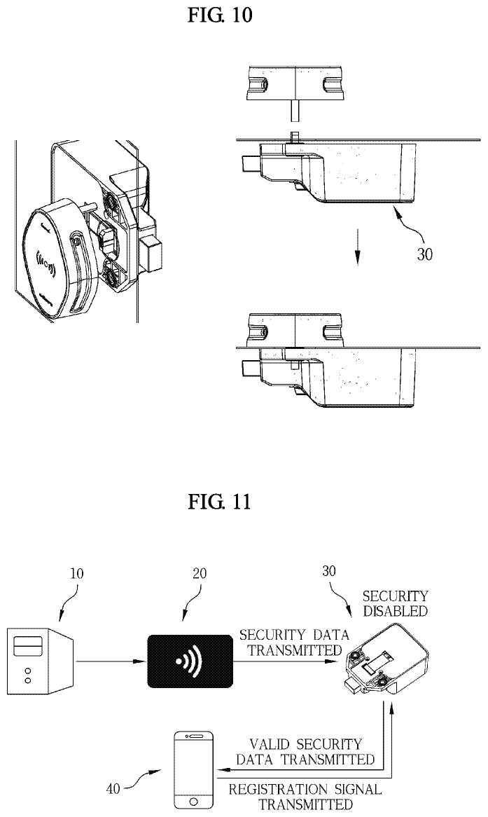

FIG. 8 is a view showing a detailed structure of a cover plate according to an embodiment of the present invention and a method of installing the locking unit on a common wooden locker, FIG. 9 is a view showing an example when an electrical cable is accommodated on a cover plate according to an embodiment of the present invention, and FIG. 10 is a view showing in detail the locking unit installed on a thin metal locker in accordance with the accommodation type shown in FIG. 9.

A accommodation guide groove 312b that extends with a predetermined length from the electrical cable hole 312a and is recessed with a predetermined length is formed on the outer surface of the cover plate 312 and a connector accommodation groove 312c that has a size corresponding to a connector at an end of the electrical cable and in which the connector is accommodated is formed at an end of the guide groove 312b.

When the locking unit is installed on a wooden locker having a common thickness, the electrical cable extends outward from the cover plate 312 and extends from the cover plate 312 installed on the inner surface of the wooden locker to a control board body installed on the outer surface of the wooden locker due to the thickness of the wooden locker.

In this case, the locking unit can be installed on the control board body only when the electrical cable is sufficiently long, but, as shown in FIG. 10, it is difficult to accommodate the electrical cable when installing the locking unit on a thin metal locker, for example, in a locker room.

Accordingly, in the present invention, as described above, the guide groove 312b and the connector accommodation groove 312c are separately formed on the outer surface of the cover plate 312 so that the electrical cable makes a plane with the cover plate 312. Accordingly, it is very convenient to handle the cable and the remaining portion of the cable is stowed in the casing 300. Further, the connector at the end of the electrical cable is fixed in the connection accommodation groove 312c and is directly coupled to a terminal of a control board body through a hole formed through a metal locker, so the connector can be very conveniently coupled.

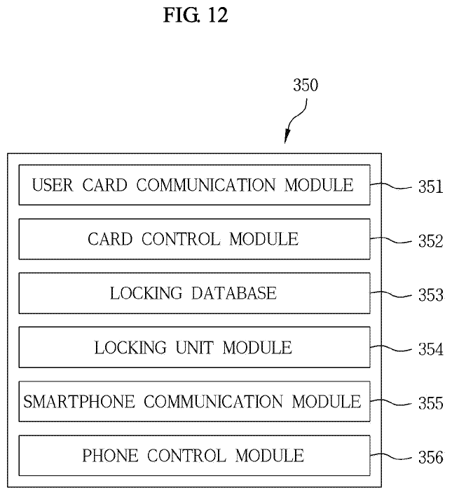

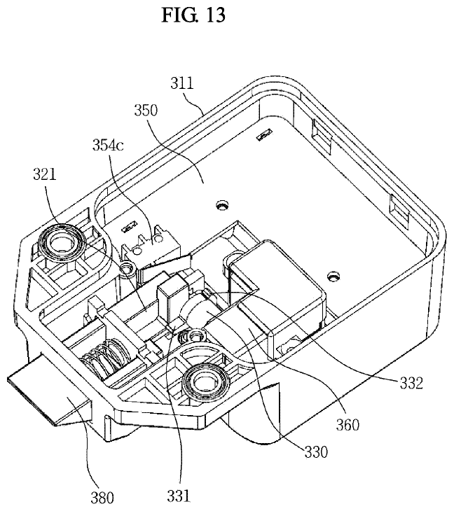

FIG. 11 is a view simply showing a control method that is performed with a smartphone using a locking unit and FIG. 12 is a view showing the detailed configuration of the driving controller according to an embodiment of the present invention.

A locking device that uses a smartphone according to an embodiment of the present invention includes a management server 10, a user card 20, a locking unit 30, and a smartphone 40.

In general, when valid security data are transmitted from the user card 20 to the locking unit 30 using electric waves under the assumption that the user car 20 is a valid and available card, security of the locking unit 30 is disabled so that a locker is opened. However, in the present invention, after the process described above is performed, when the smartphone 40 is put close to the locking unit 30 without contact, with security disabled, valid security data are transmitted from the locking unit to the smartphone 40, whereby the smartphone 40 is registered.

Accordingly, the registered smartphone 40 can function as a ‘smartphone key’, so a user is enabled to disable security of the locking unit 30 using the smartphone 40 that he/she carries even without carrying the user card 20.

For this control, the driving controller 350 according to the present invention includes: a user card communication module 351 that receives security data from the user card 20 keeping the security data; a card control module 352 that authenticates the user card 20 by examining validity of the security data received by the user card communication module 351; a locking database that keeps security data validated by the card control module 352; a locking unit module 354 that disables security of a locker when security data is validated and the user card 20 is authenticated by the card control module 352; a smartphone communication module 355 that performs communication with the smartphone 40; and a phone control module 356 that controls the smartphone communication module 355 to transmit security data validated by the card control module 352 to the smartphone 40 when the smartphone 40 requests security data validated by the card control module 352 to be transmitted through the smartphone communication module 355, in which the smartphone 40 functions as an unlocking key.

Further, the security data includes a multi-user setting, an encoding setting, a locking time setting, IDs, an available period of the security data, and various functions such as a last use time setting, and it is possible to disable security of a locker through the smartphone 40 by transmitting the security data to the smartphone 40.

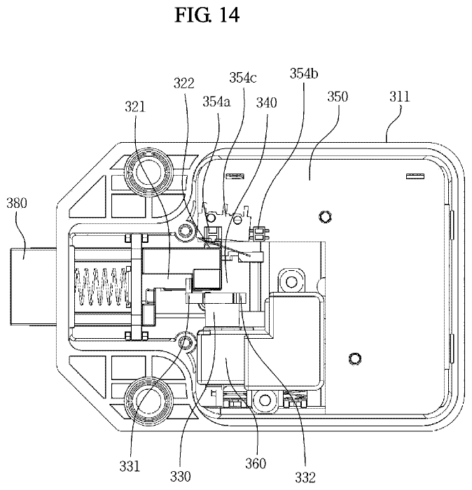

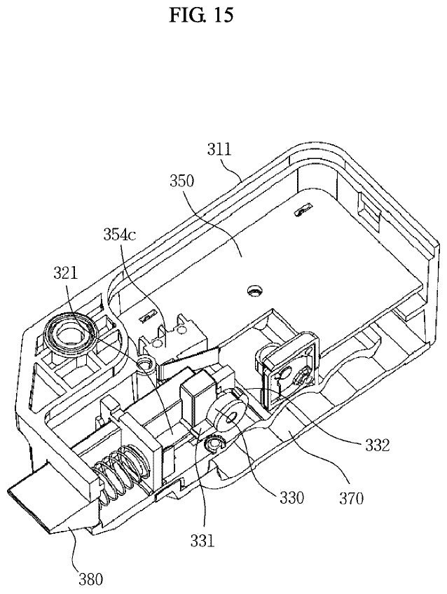

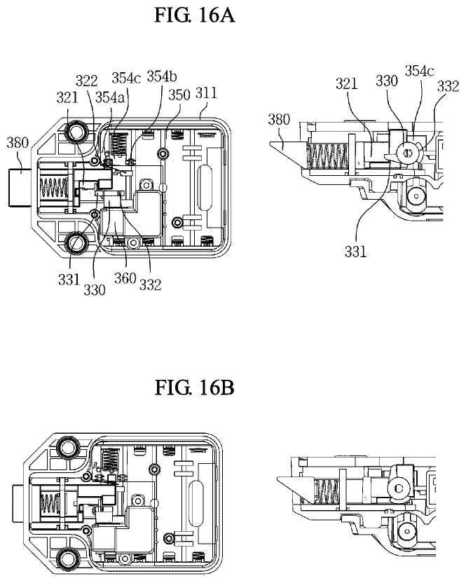

FIG. 13 is a perspective view showing a locking unit according to another embodiment of the present invention with a cover thereof removed, FIG. 14 is a plan view showing the locking unit according to another embodiment of the present invention with the cover thereof removed, and FIG. 15 is a perspective view showing a cross-sectional structure the locking unit according to another embodiment of the present invention with the cover thereof removed.

In order to use a locking unit 30 according to another embodiment of the present invention in a spring latch 380 mode, unlike the previous embodiment of the present invention, the spring latch mode 380 is achieved only by operating the latch operation lever 330 without the stopper plate 340 that restricts movement of the latch operation lever 330.

The locking unit 30 according to another embodiment of the present invention includes a casing 300, a deadbolt latch 320, a latch operation lever 330, a driving controller 350, a motor driving unit 360, and a battery unit 370.

The casing 300 includes: a housing 311 having an open top and having an component installation space therein; and a cover plate 312 having an electrical cable hole 312a to expose an electrical cable installed in the housing 311 to the outside, covering the open top of the housing 311, and being installed in close contact with a side of a locker.

The spring latch 380 that is disposed in the casing 300 with a first end exposed out of the casing 300 and moves forward/backward in the casing 300 to open and close a locker. The spring latch 380 is longitudinally moved forward by a pressing force from an elastic spring disposed in the casing 300 such that the first end is exposed out of the casing 300. A locking portion 380 separately protruding to come in contact with the latch operation lever 330 is formed on the other side of the spring latch 320.

The latch operation lever 330 is disposed in the casing 300 to be rotated by a motor force. When the latch operation lever 330 is rotated in a specific direction, a locking protrusion 331 on a surface of the latch operation lever 330 is locked to or unlocked from the locking portion 321 on the other side of the spring latch 380, thereby restricting forward/backward movement of the spring latch 380.

The driving controller 350 controls the latch operation lever 330 to be rotated in a specific direction or to a specific angle by a motor force. The driving controller 350 includes a locking unit module and determines a locked state of a locker by sensing a movement state of the deadbolt latch 320.

The locking unit module includes a plurality of first and second proximity sensors 354a and 354b at positions corresponding to movement positions of the spring latch 380 that correspond to a locked state and an unlocked state of a locker to determine the operation state of the spring latch 380 to open a locker using sensing values acquired by the first and second proximity sensors 354a and 354b.

In more detail, the proximity sensors of the present invention may be photo sensors, a photo sensor receiver 322 is installed at the second end of the spring latch 380, and the first proximity sensor 354a is installed at a position corresponding to the photo sensor receiver 322 at the movement position of the spring latch 380 that corresponds to a locked state of a locker. Accordingly, when sensing is performed though the first proximity sensor 354a, it is determined that a locker is now in a locked state.

Further, the second proximity sensor 354b is installed at a position corresponding to the photo sensor receiver 322 at the movement position of the deadbolt latch 320 that corresponds to an unlocked state of a locker, so when sensing is performed by the second proximity sensor 354b, it is determined that a locker is in an unlocked state to be able to open with the first end of the deadbolt latch 320 moved backward without being exposed out of the casing 300. The sensing values obtained by the proximity sensors can be transmitted to the driving controller 350 so that the operation of a motor is controlled on the basis of the sensing values.

A micro switch 354c is installed at the second end portion of the deadbolt latch 320 so that the deadbolt latch 320 comes in contact with the micro switch 354c while reciprocating in the casing 300 and a locked state and an unlocked state of a locker are determined by connection/disconnection of the micro switch 354c.

The motor driving unit 360 is connected to a side of the latch operation lever 330 and is controlled by the driving controller 350 to rotate the latch operation lever 330 in a specific direction.

The battery unit 370 is disposed at a side in the casing 300 and is controlled by the driving controller 350 to apply power to the motor driving unit 360.

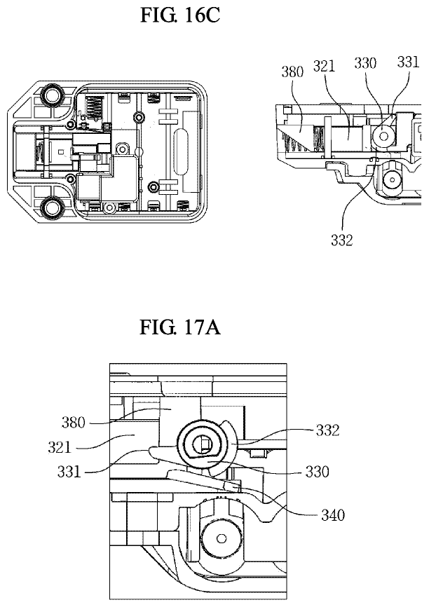

FIGS. 16A to 16C are views illustrating an open state of a locker by rotation of a latch operation lever according to another embodiment of the present invention.

FIG. 16A shows that the first end portion of the latch operation lever 330 is fully exposed out of the casing 300 and a locker is in a locked state. In this locked state of a locker, as shown in the cross-sectional structure, the locking protrusion 331 of the latch operation lever 330 is positioned in a locking groove of the spring latch 380, but when the spring latch 380 is moved backward, the locking protrusion 331 does not restrict the movement of the spring latch 380. Accordingly, the spring latch 380 can freely move forward/backward, so the spring latch 380 mode is achieved.

FIG. 16B shows the latch operation lever 330 rotating in response to an unlocking control instruction to forcibly open a locker, in which as the latch operation lever 330 rotates, the locking protrusion 331 of the latch operation lever 330 is locked into a locking groove of the spring latch 380, thereby moving the spring latch 380 backward. Next, as shown in FIG. 16C, the latch operation lever 330 pulls the spring latch 380 while keeping rotating clockwise, so the first end portion of the spring latch 380 moves into the casing 300, whereby a locker is forcibly opened.

The locking unit 30 according to another embodiment of the present invention is implemented in the same way as the control method that uses the smartphone 40 in the previous embodiment of the present invention, so detailed description is omitted.

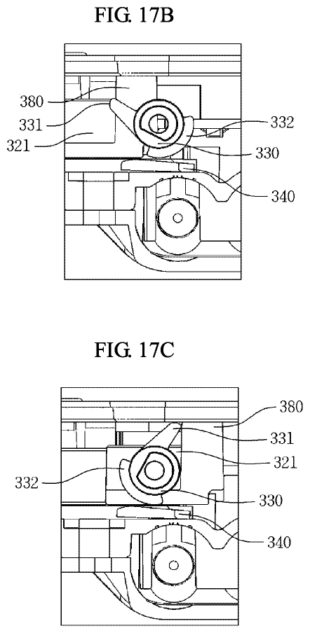

FIGS. 17A to 17C are views illustrating a structure enabling a locking unit to perform both the function of a deadbolt latch and the function of a spring latch by rotation of a latch operation lever according to another embodiment of the present invention.

In another embodiment of the present invention, in a locking unit 30 having the structure of the previous embodiments, a spring latch 380 having an inclined surface with a first end portion that slides on a doorframe is provided instead of the deadbolt latch 320 such that the locking unit 30 can achieve both the function of a deadbolt latch and the function of a spring latch, depending on the rotational angle of the latch operation lever 330.

FIG. 17A shows the state in which the function of a deadbolt latch is achieved. In this case, the pressing protrusion 322 of the latch operation lever 330 does not press the stopper plate 340, in which the first end portion of the stopper plate 340 is positioned at the second end portion of the spring latch 380, whereby the spring latch 380 no longer moves backward and a locker is in a locked state.

In FIG. 17B, when the latch operation lever 330 rotates 45° clockwise, the pressing protrusion 332 presses down the stopper plate 340, so the first end portion of the stopper plate 340 comes out of the forward/backward movement range of the spring latch 380, whereby the spring latch 380 freely moves forward/backward. At this rotational angle, the locking protrusion 331 is not locked to the locking portion 321 of the spring latch 380 and the latch operation lever 330 does not pull the spring latch 380 backward when rotating. In this state, when a locker is opened and closed, the spring latch 380 can perform its original function while sliding forward/backward.

In FIG. 17C, the latch operation lever 330 rotates 125° clockwise, in which the locking protrusion 331 pulls the spring latch 380 backward by coming in contact with the locking portion 321 of the spring latch 380, so the first end portion of the spring latch 380 moves into the casing 300, thus keeping a locker open.

Further, in this embodiment of the present invention, by making it possible to adjust the latch operation lever 330 using a sensor, it is possible to change the function modes by rotating latch operation lever 330 to specific angles in accordance with requests from a user.

Although the present invention was described with reference to exemplary embodiments, the present invention may be changed or modified in various ways without departing from the spirit and scope of the present invention. Therefore, the range of claims may include such changes and modifications pertaining to the scope of the present invention.

What is claimed is:

1. A locking device for a locker, the locking device comprising a locking unit that includes:
a casing including a cover that is attached to a side of a locker;
a deadbolt latch being moved longitudinally forward by a pressing force from an elastic spring disposed in the casing such that a first end portion is exposed out of the casing, and having a locking portion on a second side;
a latch operation lever disposed in the casing to be rotated by a motor force and rotating in a specific direction to be locked to or unlocked from the locking portion of the deadbolt latch, thereby restricting movement of the deadbolt latch;
a stopper plate having a first side fixed to an inner side of the casing and a second side protruding in a movement area of the deadbolt latch;
a driving controller controlling the latch operation lever to be rotated in the specific direction at a specific angle by the motor force;
a motor driving unit connected to a side of the latch operation lever to rotate the latch operation lever; and
a battery unit disposed at a side in the casing and being controlled to apply power to the motor driving unit by the driving controller,
wherein a second end portion of the deadbolt latch is locked to a second side of the stopper plate such that the deadbolt latch is not moved backward, thereby keeping a locker locked.

2. The locking device of claim 1, wherein a pressing protrusion continuously protruding with a predetermined length is formed on an outer circumference of the latch operation lever, so when the latch operation lever rotates a predetermined angle, the pressing protrusion slides on an outer surface of the stopper plate, the stopper plates is moved to the inner side of the casing, the second end portion of the deadbolt latch is unlocked from the second end portion of the stopper plate, and the locker is unlocked.

3. The locking device of claim 2, wherein the casing includes:
a housing having an open top and having a component installation space therein; and
a cover plate having an electrical cable hole to expose an electrical cable disposed in the housing to the outside and being installed on a side of locker in close contact with the side of the locker while covering the open top of the housing,
wherein an accommodation guide groove extending with a predetermined length from the electrical cable hole and recessed with a predetermined length is formed on an outer surface of the cover plate; and a connector accommodation groove having a size corresponding to a connector at an end of the electrical cable and accommodating the connector formed at an end of the guide groove.

4. The locking device of claim 2, wherein the driving controller includes a locking unit module that determines a locked state of a locker by sensing a movement state of the deadbolt latch, and
the locking unit module includes a plurality of first and second proximity sensors disposed at positions corresponding to movement positions of the deadbolt latch that correspond to the locked state and an unlocked state of the locker to determine the locked state and the unlocked state of the locker using sensing values acquired by the first and second proximity sensors.

5. The locking device of claim 4, wherein the locking unit keeps security of a locker or disables the locker by examining validity of security data transmitted from a user card,
the locking device further includes a smartphone receiving and keeping validated security data from the locking unit,
wherein the smartphone transmits the kept security data to the locking unit to induce disabling security of the locker.

6. The locking device of claim 5, wherein the driving controller includes:
a user card communication module receiving security data from the user card keeping the security data;
a card control module authenticating the user card by examining validity of the security data received by the user card communication module;
a locking database keeping security data validated by the card control module;
a locking unit module disabling security of a locker when security data is validated and the user card is authenticated by the card control module;
a smartphone communication module performing communication with the smartphone; and
a phone control module controlling the smartphone communication module to transmit security data validated by the card control module to the smartphone when the smartphone requests security data validated by the card control module to be transmitted through the smartphone communication module.

7. The locking device of claim 6, wherein the security data includes a multi-user setting, an encoding setting, a locking time setting, IDs, an available period of the security data, and a last use time setting, and the security data are transmitted to the smartphone such that security of a locker is disabled by the smartphone.

8. A locking device for a locker, the locking device comprising a locking unit that includes:
a casing including a cover that is attached to a side of a locker;
a spring latch being moved longitudinally forward by a pressing force from an elastic spring disposed in the casing such that a first end portion is exposed out of the casing, and having a locking portion on a second side;
a latch operation lever disposed in the casing to be rotated by a motor force and rotating in a specific direction to be locked to or unlocked from the locking portion of the spring latch, thereby restricting movement of the deadbolt latch;
a driving controller controlling the latch operation lever to be rotated in the specific direction at a specific angle by the motor force;
a motor driving unit connected to a side of the latch operation lever to rotate the latch operation lever; and
a battery unit disposed at a side in the casing and being controlled to apply power to the motor driving unit by the driving controller,
wherein when the spring latch moves forward/backward, the locking unit implements a spring latch function.

9. The locking device of claim 8, wherein the casing includes:
a housing having an open top and having a component installation space therein; and
a cover plate having an electrical cable hole to expose an electrical cable disposed in the housing to the outside and being installed on a side of locker in close contact with the side of the locker while covering the open top of the housing,
wherein an accommodation guide groove extending with a predetermined length from the electrical cable hole and recessed with a predetermined length is formed on an outer surface of the cover plate; and a connector accommodation groove having a size corresponding to a connector at an end of the electrical cable and accommodating the connector formed at an end of the guide groove.

10. The locking device of claim 8, wherein the driving controller includes a locking unit module that determines a locked state of a locker by sensing a movement state of the deadbolt latch, and
the locking unit module includes a plurality of first and second proximity sensors disposed at positions corresponding to movement positions of the deadbolt latch that correspond to the locked state and an unlocked state of the locker to determine the locked state and the unlocked state of the locker using sensing values acquired by the first and second proximity sensors.

11. The locking device of claim 10, wherein the locking unit keeps security of a locker or disables the locker by examining validity of security data transmitted from a user card,
the locking device further includes a smartphone receiving and keeping validated security data from the locking unit,
wherein the smartphone transmits the kept security data to the locking unit to induce disabling security of the locker.

12. The locking device of claim 11, wherein the driving controller includes:
a user card communication module receiving security data from the user card keeping the security data;
a card control module authenticating the user card by examining validity of the security data received by the user card communication module;
a locking database keeping security data validated by the card control module;
a locking unit module disabling security of a locker when security data is validated and the user card is authenticated by the card control module;
a smartphone communication module performing communication with the smartphone; and
a phone control module controlling the smartphone communication module to transmit security data validated by the card control module to the smartphone when the smartphone requests security data validated by the card control module to be transmitted through the smartphone communication module.

13. The locking device of claim 12, wherein the security data includes a multi-user setting, an encoding setting, a locking time setting, IDs, an available period of the security data, and a last use time setting, and the security data are transmitted to the smartphone such that security of a locker is disabled by the smartphone.

14. A locking device for a locker, the locking device comprising:
a casing including a cover that is attached to a side of a locker;
a deadbolt latch being moved longitudinally forward by a pressing force from an elastic spring disposed in the casing such that a first end portion is exposed out of the casing, and having a locking portion on a second side;
a latch operation lever disposed in the casing to be rotated by a motor force and rotating in a specific direction such that a locking protrusion formed on a surface is locked to or unlocked from the locking portion of the deadbolt latch, thereby restricting movement of the deadbolt latch;
a stopper plate having a first side fixed to an inner side of the casing and a second side protruding in a movement area of the deadbolt latch;
a driving controller controlling the latch operation lever to be rotated in the specific direction at a specific angle by the motor force;
a motor driving unit connected to a side of the latch operation lever to rotate the latch operation lever; and
a battery unit disposed at a side in the casing and being controlled to apply power to the motor driving unit by the driving controller,
wherein a second end portion of the deadbolt latch is locked to a second side of the stopper plate by rotation of the latch operation lever to implement a deadbolt latch function such that the deadbolt latch is not moved backward; and
a pressing protrusion continuously protruding with a predetermined length is formed on an outer circumference of the latch operation lever, so when the latch operation lever rotates a predetermined angle, the pressing protrusion slides on an outer surface of the stopper plate, the stopper plates is moved to the inner side of the casing, the second end portion of the deadbolt latch moves forward and backward without being locked to the second end portion of the stopper plate to implement a spring latch function.
